(19) United States
(12) Patent Application Publication
(10) Pub. No.: US 2014/0214759 A1
(43) Pub. Date: Jul. 31, 2014

(54) TRANSACTION DOCUMENT STORAGE

(71) Applicant: Cardlink Services Limited, Rhodes NSW (AU)

(72) Inventors: Richard Mark Williams, Rhodes NSW (AU); Keith Robert Goding Brown, Rhodes NSW (AU)

(73) Assignee: Cardlink Services Limited, Rhodes NSW (AU)

(21) Appl. No.: 14/230,288

(22) Filed: Mar. 31, 2014

Related U.S. Application Data
(63) Continuation of application No. PCT/AU2011/001268, filed on Sep. 30, 2011.

(51) Int. Cl. G06F 17/30

(52) U.S. Cl. CPC G06F 17/30011
USPC 707/608

(57) ABSTRACT

The present disclosure concerns computing systems of financial institutions and computing systems that interact and support functions of financial institutions, including the exchange of documents between two users of the system. When implemented as a computer the computer provides access for a user to a document. The computer receives from a sending party document data and a user identifier and determines a document identifier and the receiving financial institution. The computer then sends to a receiving financial institution the document identifier and the user identifier causing the receiving financial institution to display information related to the document identifier to the user such that the user can request the document. The computer then receives from the receiving financial institution a request from the user for the document. The computer determines a document reference and a document storage provider and provides access to the document.

### CROSS-REFERENCE TO RELATED APPLICATIONS

This application is a continuation of International Application No. PCT/AU2011/001268, filed on Sep. 30, 2011. The disclosure of the above application is incorporated herein by reference.

Incorporated here by reference is Australian provisional patent application No. 2011902123 entitled “Addresses in financial systems” filed on 31 May 2011.

Incorporated here by reference is PCT application also filed with the Australian Patent Office this day entitled “Payment requests” with Cardlink Services Limited also identified as the applicant.

Incorporated here by reference is PCT application also filed with the Australian Patent Office this day entitled “Online payment” with Cardlink Services Limited also identified as the applicant.

### FIELD

The disclosure concerns computing systems of financial institutions and computing systems that interact and support functions of financial institutions. The disclosure includes a description of methods, computer systems and software.

### BACKGROUND

The statements in this section merely provide background information related to the present disclosure and may not constitute prior art.

Electronic funds transfer (EFT) is used extensively to transfer money from a payer account to a payee account or to pay for goods and services at point of sale (POS). Using EFT, a payer can provide a text, such as a customer reference number, with the payment. While the use of EFT has increased with the availability of the Internet, the text that can be provided with the transfer is still limited to a small number of characters.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In a first aspect there is provided a computer implemented method performed by a central financial management system for enabling a user to access a document, the method comprising:
(a) receiving from a sending party document data describing the document and a user identifier;
(b) determining a document identifier associated with the document data;
(c) determining the receiving financial institution (receiving FI) based on the user identifier;
(d) sending to a receiving FI the document identifier and the user identifier to cause the receiving FI to provide information related to the document identifier to the user associated with the user identifier such that the user can request the document;
(e) receiving from the receiving FI a request to enable access to the document for the user, the request including the document identifier;
(f) determining a document reference and a document storage provider associated with the received document identifier; and
(g) enabling access for the user associated with the user identifier to the document stored at the storage provider associated with the document reference.

It is an advantage that one single user identifier and document identifier is used throughout the method.

The document data may include the document reference and step (b) of determining a document identifier may comprise generating the document identifier and storing on a datastore an association between the document reference and the document identifier.

It is an advantage that the sending party provides a document reference to the central financial management system. As a result, the sending party can send the same document reference to multiple different users using respective different user identifiers and all these users access the same version of the document referenced by the document reference.

Alternatively, the document data includes the document and step (b) of determining a document identifier comprises:
storing the document on a datastore;
determining a document reference as the reference to the document on the datastore;
generating a document identifier associated with the document; and
storing on the datastore an association between the document and the document identifier. This method may further include determining a document reference as the reference to the document on the datastore, and the association between the document and the document identifier may be between the document identifier and the document reference.

It is an advantage that the central financial management system can store the document. As a result, no external document storage provider is needed. It is a further advantage that the central financial management system can provide the document identifier to the sending party. As a result, the sending party can use this document identifier to grant access to the same document to other users using different user identifiers.

The method may further comprise validating the document reference or document.

Step (b) may further comprise determining the receiving FI based on the user identifier and user data stored on a datastore of the central financial management system having the associated with each user identifier a financial institution.

The method is typically executed in real time. The user identifier may be associated with a financial transaction.

In another aspect there is provided software, that is, computer readable instructions recorded on computer readable media, that when executed by a computer causes the computer to perform the method described directly above.

In yet another aspect there is provided a computer system of a central financial management service provider for enabling a user to access a document, the system comprising:
one or more communication ports; and
one or more processors to operate the communications port to:
(a) receive from a sending party document data describing the document and a user identifier;
(b) determine a document identifier associated with the document data;
(c) determine the receiving financial institution (receiving FI) based on the user identifier;
(d) send to a receiving FI the document identifier and the user identifier to cause the receiving FI to provide information related to the document identifier to the user associated with the user identifier such that the user can request the document;
(e) receive from the receiving FI a request to enable access to the document for the user, the request including the document identifier;
(f) determine a document reference and a document storage provider associated with the received document identifier; and
(g) enable access for the user associated with the user identifier to the document stored at the storage provider associated with the document reference.

In a further aspect there is provided a computer system for enabling a user to access a document where the document is sent to the user, the computer system comprising:
a persistence layer to store user data including a user identifier and associated user financial institution (FI), and, a document identifier and associated storage provider and user rights access;
a communication and mediation layer to receive an output message from a service layer, to send the output message to a recipient, to receive an input message from a sender, to validate the input message and to send the input message to the service layer; and the service layer
   to receive from the communication and mediation layer the input message,

where the input message includes a user identifier and document data, to determine a document identifier associated with the document data, to determine the FI based on the user identifier and the user data in the persistence layer; to create an output message having the FI as the recipient and including the document identifier and the user identifier that cause the FI to provide information related to the document identifier to the user associated with the user identifier such that the user can request the document, to send the output message to the communication and mediation layer, and

where the input message includes a request to enable access to the document for the user and includes the a document identifier, to determine a document storage provider and user access rights associated with the document identifier based on the document identifier in the persistence layer, to create an output message that will enable access to the document by the user from the storage provider, to send the output message to the communication and mediation layer.

In a further aspect there is provided a computer implemented method performed by a financial institution of a sender for providing a document to a user, the method comprising:
(a) receiving from the sender a request to register the document including document data describing the document and a user identifier; and
(b) sending to a central financial management system a message including the request to register the document.

A further aspect there is provided software, that is, computer readable instructions recorded on computer readable media, that when executed by a computer causes the computer to perform the method described directly above.

In yet a further aspect there is provided a computer system of a financial institution of a sender for providing a document to a user, the system comprising:
one or more communications ports; and
one or more processors to operate the communications port and to perform the method described directly above.

In another aspect there is provided a computer implemented method performed by a financial institution of a user to enable access to a document sent by a sender to the user, the method comprising:
(a) receiving a document identifier and a user identifier;
(b) determining the user associated with the user identifier;
(c) providing information related to the document identifier to the user associated with the user identifier
(d) receiving from the user a request for the document associated with the document identifier; and
(e) sending a request to enable access to the document for the user, the request including the document identifier.

In a further aspect there is provided software, that is, computer readable instructions recorded on computer readable media, that when executed by a computer causes the computer to perform the method described directly above

In yet another aspect there is provided a computer system of a financial institution of a user for facilitating a payment from a payer to a payee, the system comprising:
one or more communications ports; and
one or more processors to operate the communications port and to perform the method described directly above.

We note that the optional features of the first aspect described here are also optional features of the remaining aspects (where appropriate).

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 schematically illustrates a financial grade information systems used in this example to support document access;

FIG. 2a illustrates a method 200 for storing and registering documents. attached to a payment from a receiver to a sender;

FIG. 2b illustrates a method for requesting a document;

FIG. 3 illustrates the computer implemented method performed by the central financial management system (CFMS);

FIG. 4 schematically shows the applications layers of the CFMS.

FIG. 5 schematically shows the state transitions of a state machine of the CFMS;

FIG. 6 illustrates a method of determining settlement details; and

FIG. 7 illustrates data on a data store if the CFMS.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

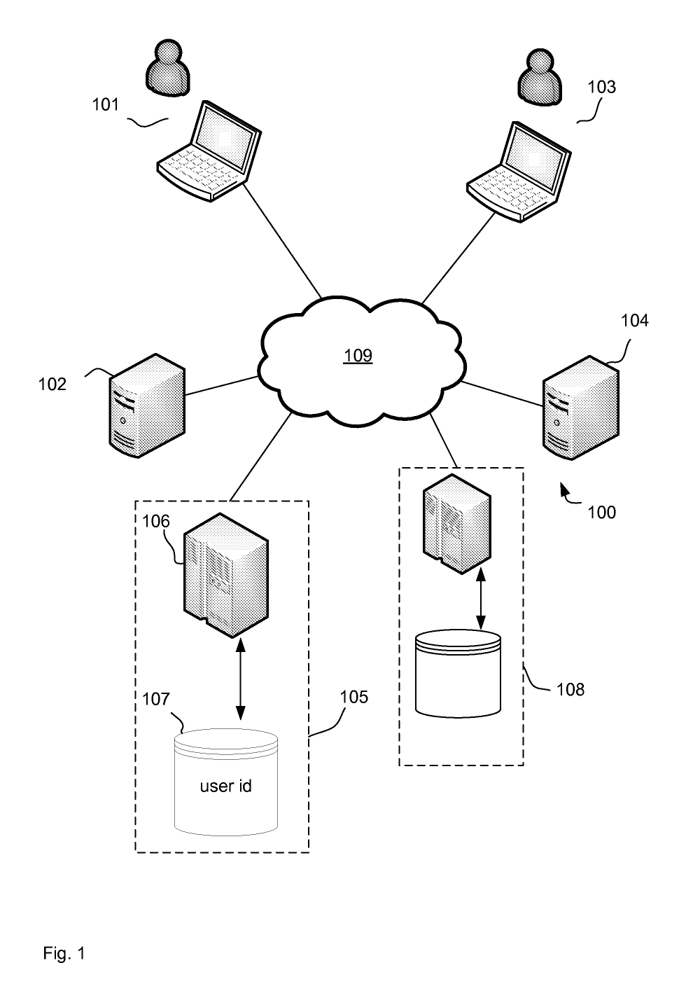

FIG. 1 illustrates a financial grade information system, such as an online transaction documents storage system 100 comprising a receiver of documents 101 who has one or more accounts with a receiver financial institution (FI) 102. The system also comprises a sender of documents 103 who has one or more accounts with a sender FI 104. The receiver 101 receives from the sender 103 a document.

In one example, the receiver 101 is a payer and the sender 103 is a payee and the document is an invoice and is attached to a payment request from the sender 103 to the receiver 103. In a different example, the receiver 101 is the payee (now payer) and the sender 103 is the payer (now payee) and the document is a remittance advice and is attached to a payment from the sender 103 to the receiver 101. Of course, the method for storing the document as described below can be performed twice, the first time in relation to the invoice and the second time in relation to the remittance advice.

Throughout this document, the word “transaction” is not limited to actions that result in transfer of funds, such as payments. Transactions comprise multiple steps of communication between the different parties involved. In one example, the document is attached to a transaction that is not related to any transfer of funds. The document, such as a prospectus, is sent to multiple receivers, such that each receiver accesses the exact same stored copy of the document.

Both receiver 101 and sender 103 may be individuals, such as natural persons, or non-individuals, such as companies. The sender 103 may also be an online merchant or a restaurant. The receiver 101 and sender 103 may be any entity that holds an account with their respective FI. Both the receiver 101 and sender 103 are registered with a central financial management system (CFMS) 105 in order to participate in this method. The sender as described here should be understood to include an authorised service provider.

The information system 100 comprises the CFMS 105 including one or more processors, that is a computer processing system such as a server 106 and a computer storage (datastore) 107 such as non-volatile memory. Also part of the information system 100 is a document storage host 108 that also includes on or more processors and a computer storage (datastore) such as non-volatile memory.

The receiver 101, receiver FI 102, sender 103, sender FI 104, CFMS 105 and document storage host 108 are connected via communication I/O ports using a computer communication network, such as the Internet 109 or other wide area networks (WANs). As described further below, in this example messages sent to or from the I/O ports are comprised of data wrapped in Extended Marked-up Language (XML). Each message associated with the same transaction includes a unique transaction identifier allowing the different parties to associate subsequent messages received and sent relating to the particular transaction. For example, if the transaction is a payment, then a payment request and payment notification include the same transaction identifier.

The computer storage 107 of CFMS 105 stores for each receiver or sender, the following information as appropriate:

user data for the receiver 101 and sender 103, that is a unique user identifier and FI associated with the user identifier,

display details, such as the name published with the user identifier, the user type (e.g. individual, business, government), official identification numbers (e.g. ABN, ACN),

allowable usage information (e.g. accept real time notifications? payment requests? online transactions? send documents? receive documents?),

blocked list information, that is other user identifiers that are blocked from sending messages to this user identifier,

limit information, minimum and maximum values that can be received or sent by the user identifier,

transaction history, that is information of all transactions performed using the identifier stored by the CFMS 105 as they occurred,

other information associated with the identifier, such as auto pay rules and scheduled payment information.

The CFMS 105 also stores in the computer store 107 document references to documents stored on the document storage host 108. Each of these document references is uniquely associated with a document identifier and a document storage host identifier, such as the internet address of the document storage host.

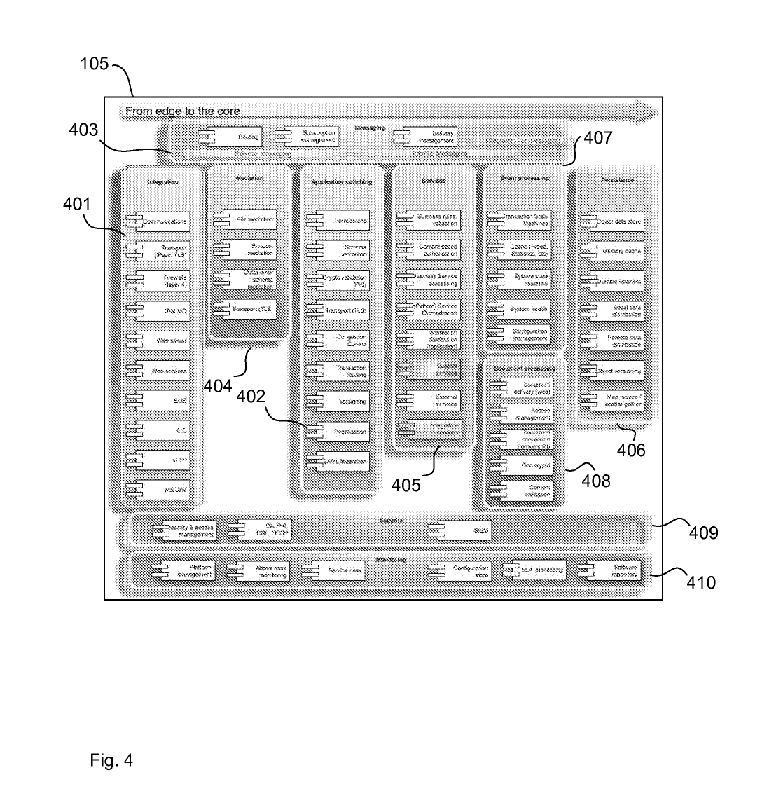

The CFMS 105 also has installed software that the sever executes to perform the method described here, which includes querying and updating the computer storage 107 and generating and sending messages to the receiver FI 102, sender FI 104 and doc host as appropriate This is described in more detail further below in relation to FIG. 4.

The receiver FI 102 also has computer storage (not shown) that stores for each receiver identifier:
associated account information, such as account identification information and current balance,
transaction information, including received payments or documents previously sent or received.

The receiver FI 102 also has installed software that a processor executes to perform the method described here.

The sender FI 104 also has computer storage (not shown) that stores for each sender identifier:
associated account information, such as account identification information and current balance,
transaction information, including received payments or documents previously sent or received.

The sender FI 104 also has installed software that a processor executes to perform the method as described here.

For simplicity only one receiver 101, receiver FI 102, sender 103 and sender FI 104 are shown in FIG. 1, however it should be understood that in practice multiples of each entity each using one or more computer systems participate in this system 100. Also, in some cases the receiver FI 102 and the sender FI 104 may be the same entity.

A person skilled in the art will readily appreciate the different ways the online banking facilities of FIs 102 and 104 can be accessed using a computer device, such as a personal computer or smart phone. Examples include through an internet browser or a dedicated software application (software app) or smart phone application.

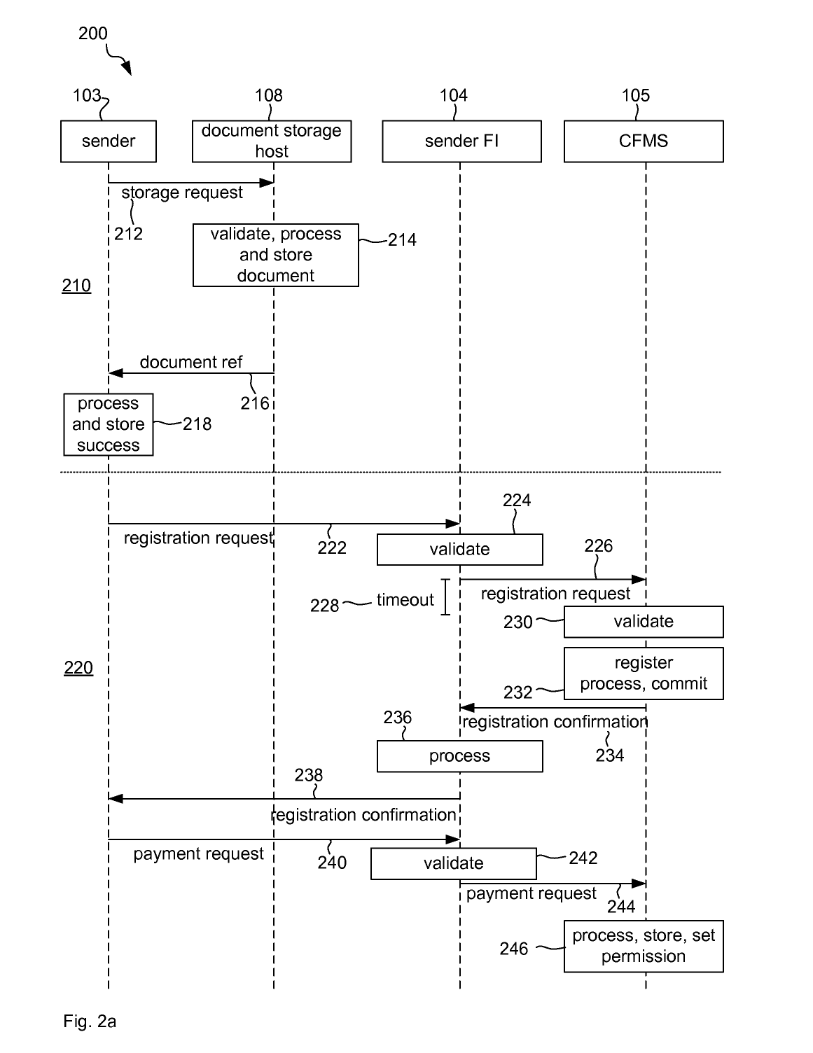

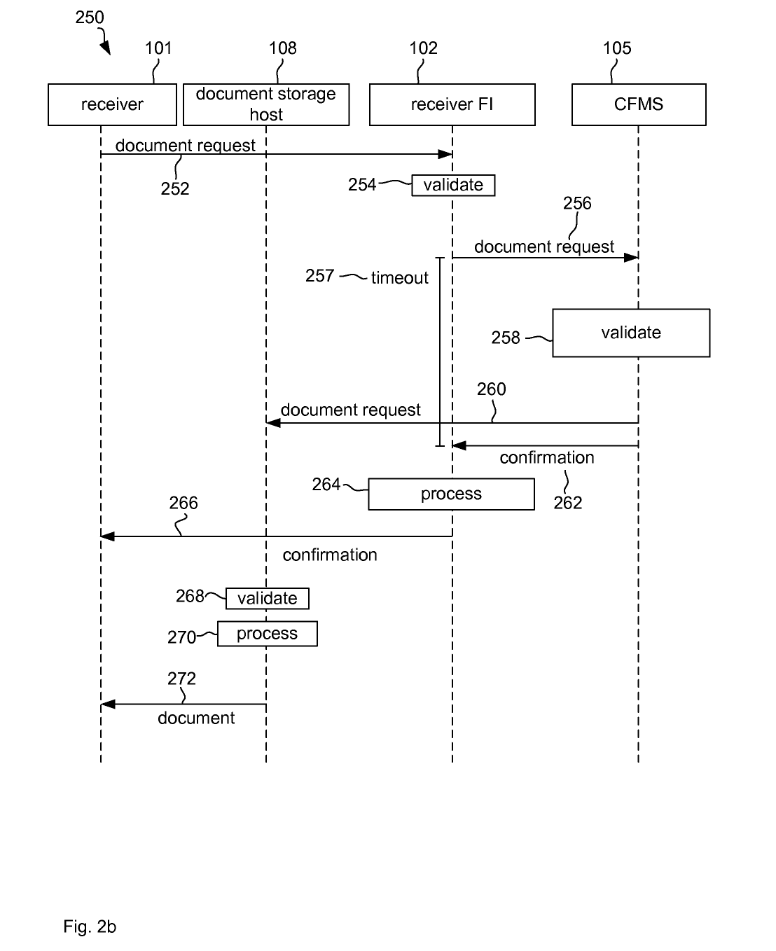

In this example, the document transfer between the sender and receiver 104 is facilitated by the CFMS 105 such that the document is available for access to the receiver a short time after it was sent by the sender, such as 5 seconds. That is the document transfer is performed in real-time. The method of this example will now be described with reference to FIGS. 2a and 2b.

FIG. 2a illustrates a method 200 for storing and registering documents. The method comprises a first part 210 for storing a document from the sender 103 on the document storage host 108 and a second part 220 for registering the document with the CFMS 105 via the sender FI 104.

The first part 210 of method 200 commences by the sender 103 sending 212 a message including a storage request having the document, such as an invoice, and associated metadata, such as the create date, to the document storage host 108.

The document storage host 108 validates 214 the metadata, the document format and security parameters. The document storage host 108 accepts a variety of document formats, such as Microsoft Word, Adobe PDF, Open Document Format, rich text format and unformatted ASCII text. The document storage host 108 processes the storage request by creating a document reference, such as a hyperlink to the document, setting the metadata associated with the document, such as date of receiving the document, and rendering a canonical document format, such as PDF/A. The canonical document format is a single, standardised format that is able to fully represent the human-readable information from the originating format. This rendering step provides that another party can read the document when the document is retrieved by that party. The document storage host 108 stores both versions of the document, the received version and the rendered version.

Finally, the document storage host 108 stores the document and sends 216 to the sender a message including a document storage confirmation having the document reference. The sender 103 processes and stores 218 the confirmation message and in particular the document reference on a data store.

The second part 220 of method 200 commences by the sender 103 sending 222 a message including a registration request having the document reference to the sender FI 104. The sender FI validates 224 the registration request and sends 226 a message including the registration request to the CFMS 105. In order to monitor the responsiveness of the CFMS 105, the sender FI 104 starts a timeout 228 that alerts the sender FI 102 if a response from the CFMS 105 has not been received within a predefined maximum response time.

The CFMS 105 validates 230 the registration request and starts the registration process 232. The registration process includes setting the transaction status (where appropriate), checking that the document reference does not already exist in the data store 107 of CFMS 105, checking that the provided document data is valid and adding a time stamp to the document reference. The CFMS 105 then stores the document reference and determines a document identifier associated with the document reference. Associated with the document identifier the CFMS 105 also stores access control data that either allows or disallows certain actions from certain user identifiers.

Documents registered with the CFMS 105 have an expiry date and these documents cannot be accessed after that date. In one example the expiry date is provided in step 222 by the sender. In a different example the expiry date is determined by the CFMS 105 as a predefined time, such as five years, after the date of registration of the document.

In one example, the message including the registration request from the sender FI 104 is a non-value item and causes no funds to be transferred.

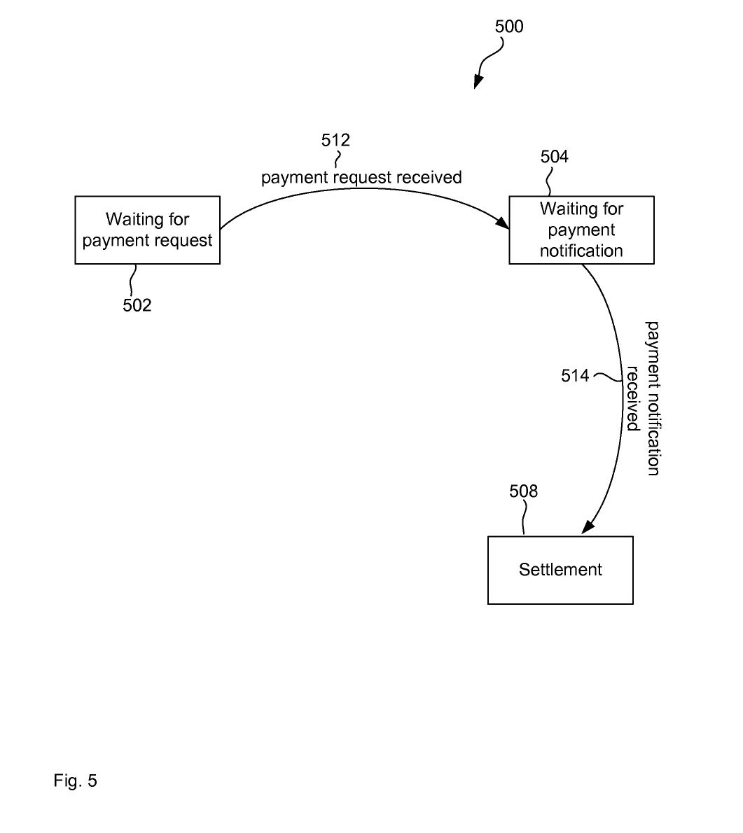

In a different example, the message including the registration request from the sender also includes a payment request with a payer user identifier and the document is an invoice. In that case, a payment transaction identifier is created, a state machine is created that is associated with the payment identifier and the payment request is sent to a payer FI determined based on the payer user identifier and user data stored on the data store 107 of CFMS 105. The state of the state machine is set to waiting for payment notification from the payer FI as will be explained later with reference to FIG. 5. In accordance with the earlier incorporation by reference we particularly refer here to the disclosure contained in the co-pending PCT application entitled “payment requests”

In another example, the message including the registration request from the sender includes a payment notification related to a payment request sent to the CFMS 105 at an earlier stage and the document is a remittance advice. In that example, the CFMS 105 validates the payment notification based on the state of the state machine and settles the payment by determining the interbank fees and the final transfer amount and writing the payment details to a settlement record table.

The CFMS 105 stores the transaction data, that is the data related to registering the document, in the data store such that a history of all transactions including registration of documents is available on the data store 107. The sender FI 104 can download the transaction history from the CFMS 105 and make the history available to the sender 103 using their secure online banking interface. Alternatively the sender FI 104 can store transaction information in real-time and as messages pass through the sender FI 104.

The CFMS 105 sends 234 a registration confirmation to the sender FI 104 and in turn the sender (not shown).

In some examples, the method 200 terminates at this point. For example when the sender 103 does not cause the document identifier to be sent to a receiver.

In other examples, in particular if no transfer of funds is involved in the registration process, the registration confirmation includes the document identifier and statistics of the CFMS 105 and the sender FI 104 sends 238 the registration confirmation including the document identifier to the sender 103. The sender 103 can then make the document available to other receivers by including the document identifier in messages relating to further transactions via the CFMS 105. In one example the document is a prospectus and the sender sends the document identifier to many receivers via the CFMS 105.

In one alternative, the sender may register the document reference with the CFMS 105 directly without the sender FI 104 or the service provider. In that case a confirmation message would be sent to the sender FI after a document is registered.

The document storage host 108 and the sender FI 104 or the service provider may be combined into a single storage and management provider. This single storage and management provider may further be integrated into the CFMS 105. In that case, a payment request may include the document itself in form of an attached file. The CFMS 105 then stores the document, associates the document reference with the document identifier and sends the document identifier to the payer without the involvement of any other party.

To summarise, there are three scenarios possible for the first message of a transaction that is received by the CFMS 105.

The first scenario is that the message includes the document itself in form of a file. In this case the CFMS 105 has integrated document storage host as described above.

The second scenario is that the CFMS 105 receives a message including a document reference to a document stored on a document storage host (either internal or external to the CFMS 105). Even if this message is not a dedicated registration request but for example a payment request, the CFMS 105 implies that registration of the document reference is requested and registers the document reference.

The third scenario is that a document identifier is included in the message and in that case the CFMS 105 proceeds with the normal processing of the message, such as sending the message including the document identifier to the receiver.

In one example as shown in FIG. 2a, the registered document is an invoice and the sender 101 sends 240 a message including a payment request to the sender FI 104 that has the receiver user identifier of the CFMS. The message also includes the document identifier as described above. The sender FI 104 validates the message 242 and sends the payment request to the CFMS 105. The CFMS 105 processes 246 the payment request and stores the payment request which includes an association to the document identifier. The CFMS 105 also adds an entry to the access control data associated with this document identifier to allow receiver user identifier to view the document.

In one example, the sender 101 specifies whether the receiver 103 is permitted to grant access to other users by attaching the same document identifier to further transactions from the receiver to the other users. In most examples, the sender 103 is not allowed to change a registered document or to update the document data. However, the sender 103 can delete a document and register a new document (which would attract a new document identifier). This way, a receiver can be confident that a document does not change.

FIG. 2b illustrates a method 250 for requesting a document. The method 250 is represented as a swim lane diagram comprising the receiver 101, the document storage host 108, the receiver FI 102 and the CFMS 105. In this example, a sender 103 (not shown in FIG. 2b) has registered a document, such as an invoice, a remittance advice or a prospectus, and has attached the document identifier to a transaction as described with reference to FIG. 2a.

The CFMS 105 has determined the receiver FI 102 for the receiver user identifier and has sent a message to the receiver FI 102 that notifies the receiver FI 102 about the transaction that includes a document, such as a document identifier, recipient user, identifier and transaction identifier.

In this example the CFMS authenticates the sender FI and not the sender itself. In one example, the messages include the receiver FI 104 and therefore, the CFMS 105 can determine the receiver FI simply from the data in the message. In a different example, the messages include the receiver user identifier (and not the receiver FI). In that case the CFMS queries the database 107 to determine the receiver FI after receiving the message. Although in this example there is another database lookup required, the process is more robust against inconsistencies due to changes in the receiver's FI.

The recipient FI then makes all transactions where the receiver user identifier is a party to the transaction available for access by the receiver.

The receiver 101 using an Internet browser software, such as Microsoft Internet Explorer, Mozilla Firefox or Google Chrome, is logged into the online banking website of the receiver FI 102 and accesses a list of transactions with its receiver user identifier as a party to the transactions. The list includes the transaction from the sender 103 described above. Alternatively, the receiver uses a smart phone in connection with a smart phone application. The online banking website or smart phone application indicates to the receiver 101 that a document is attached to the transaction such as by displaying a hyperlink or a clickable button. It is noted that more than one document may be attached to a transaction and in that case one hyperlink or clickable button is displayed for each attached document.

In one example the transaction is a payment request sent from the sender to the receiver as described with reference to FIG. 2a. The receiver 101 wishes to view the attached invoice to see the details of the payment request. The receiver 101 clicks on the hyperlink or button of the invoice which causes the browser or smart phone application to send a message including a document request to the receiver FI 102. The document request includes a receiver user identifier and a document identifier that was generated by the CFMS 105 when the sender 103 has registered the document with the CFMS 105.

The receiver FI validates 254 the document request by checking whether the input data meets minimum criteria and whether the account associated with the receiver user identifier is valid. The receiver FI 102 then sends 256 a message including the document request that includes the document identifier and the receiver user identifier to the CFMS 105. In order to monitor the responsiveness of the CFMS 105, the receiver FI 102 starts a timeout 257 that alerts the receiver FI 102 if a response from the CFMS 105 has not been received within a predefined maximum response time.

The CFMS 105 validates 258 the document request by checking the access control data associated with the document. If the receiver user identifier has permission to access the document, the CFMS 105 retrieves from the data store the document reference associated with the document identifier. The CMFS 105 creates an authorisation token and digitally signs it. The authorisation token asserts to the document host 108 that the receiver 101 is allowed to access the requested document. The authorisation token along with the URL address of the document (related to the document reference) within the document host 108 is sent 262 to the receiver FI 102.

The receiver FI 102 then processes 264 the message 262 by embedding the token inside the receiver's browser session and redirects 266 the user to the document host (to the URL that was given by the CFMS 105).

As a result of the redirect the document host 108 takes control of the browser session, validates 268 the authorisation token, including checking the document for malicious content and returns 272 the document to the receiver.

In a different example, by clicking on the link the receiver FI 102 creates an authentication token and digitally signs it. The authentication token is embedded in the browser session and the browser session is redirected to the CFMS. The authentication token validates to the CFMS that the receiver 101 is authenticated by the receiver FI. The CFMS then determines if the receiver is allowed to access the requested document and also determines the document host which stores the document and the location of the document. The CFMS then creates an authorisation token and digitally signs it. The CFMS embeds the authorisation token in the browser session and redirects to the document host 106. As a result of the redirect the document host 108 takes control of the browser session, validates the authorisation token and returns the document to the receiver.

In one example the document reference is a document number generated by the document storage host and the CFMS 105 in step 258 also determines the document storage host and creates a URL that point directly to the document on the document storage host. In a different example, the document reference is the URL to the document on the document storage host 108.

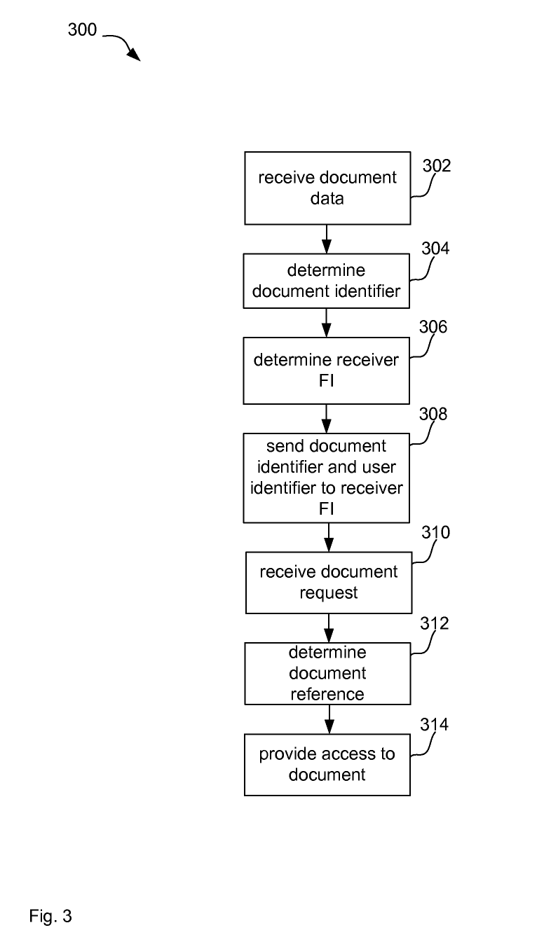

FIG. 3 illustrates as a flow diagram 300 the steps performed by the CFMS 105 in providing access for a user to a document as described above in relation to FIGS. 2a and 2b.

FIG. 4 illustrates the CFMS 105 in more detail in form of an application layer decomposition by functionality. One of the layers comprised by the CFMS 105 is an integration layer 401. This layer is the application gateway into the CFMS 105. In the OSI stack this translates into all communication from layers 4 to 7. This includes name services (DNS), including proximity and topology based DNS resolution of system resources for the clients. This is achieved by the global traffic manager (GTM) functionality of the F5 Big-IP platform. Resource based load balancing is implemented within the CFMS 105, where incoming connection requests are directed to the application host. This redirection can be based on application specific service matrix, including, sticky, round-robin or least count etc.

This layer allows to better manage the resources as well as, in event of an application node failure, it also allows to seamlessly re-direct the request to surviving application nodes. The integration layer 401 also comprises IBM MQ Services, including Queue management, routing, recovery, redundancy of traffic using IBM MQ application.

The CFMS hosts its own queue manager framework. The queue manager provides the low level technical ack, nack and time-outs functionality. Web services, for synchronous communication are also integrated into the integration layer 401. Web services are screened for security issues using the Application Security Manager (ASM) from the F5 Big-IP product modules. The integration layer 401 further comprises web servers for all web requests for document retrieval as well as file upload, download for bulk file integration using Web-based Distributed Authoring and Versioning (WebDAV) method. Connect:Direct and Secure Shell File Transfer Protocol (sFTP) is used for the file transfers. All file transfers are managed from network file shares. The file mediation services in the mediation layer make use of the file system events to initiate the file processing. This is more efficient then polling a file system.

CFMS 105 further comprises an application switching layer 402 performing the functionalities of content based routing, message validation services and Security Assertion Markup Language (SAML) federation.

The application switching layer routes messages based on “affinity” where functions are stateful, such as complex event processing functions. For example, a transaction involving two other parties should be processed at a single service tier. However, messages from participants may be delivered to via any data centres of the CFMS 105 or components within the data centres.

In the distributed CFMS 105 a message related to a transaction such as payment may be received by a location or stack not processing the specific transaction. The application switching layer 402 will identify the correct processing stack and route the message over. The routes of the messages are based on version of the schema used.

The application switching layer 402 prioritises messages based on importance of a message at a business layer, such as a block address request as part of fraud management.

The application switching layer 402 provides message validation services for confidentiality and assurance (decryption, encryption, signing, signature validation), access control (permissions and roles), technical validations (e.g., XML wellformedness) and business validations (higher level validations, if any) and SAML federation. This is used for processing document retrieval requests received by the CFMS 105. It involves validation of the assertion, invoking request to the back-end services and coordination of the response including additional SAML assertions to the caller.

CFMS 105 also comprises a messaging layer 403. The messaging layer 403 is a distributed high speed messaging tier that allows for very low latency and asynchronous message exchange in a reliable fashion. In line with the N+1 design principles, the messaging grid will autonomously recover from component failures. Each messaging server has a warm standby which allows for near instantaneous and stateful recovery with zero data loss. The messaging functionality includes queue, topics and subject based communication as well as integration with presence—for example based on Extensible Messaging and Presence Protocol (XMPP) or Remote Authentication Dial In User Service (RADIUS) events for end-point detection for transmission. The messaging functionality also includes message routing within and across the stacks and message level priority management and congestion control.

Three distinct messaging layers operate across the CFMS 105: external messaging, internal messaging and integration messaging. These layers are based on three distinct security zones. There is an additional messaging service used by the monitoring services.

Each messaging layer is to support the application services hosted at that tier and typically align with the security zones. There is no message routing crossing the security zone. All messages crossing the security zones will always go through a mediation layer 404.

Mediation layer 404 comprises message transformation services to transform messages from external to internal or vice-versa or from external to external. The mediation layer 404 also comprises orchestration functionality for integration with the core of the CFMS 105, detection of duplicates, stripping of documents and integration of document processing, bulk file iteration and response collator integration.

An internal facing mediation tier provides integration with settlement engine, which includes real time messaging integration for continuous streaming of information as the transactions take place and once a day files processing such as updates to Biller Master File (BMF). The internal facing mediation tier also provides integration with an Ops Portal that also includes file transport functionality where members can submit instructions by Bulk file and collect responses to the bulk files submitted by them. The internal facing mediation tier further provides billing and business intelligence.

CFMS 105 further comprises a service layer 405. This layer is where bulk of service functions are orchestrated based on the needs of various transactions. The services also include functionality for error correction, capturing errors and compensating actions. Some of the service functions will be bespoke to meet specific requirements. These include creation of the user identifier, transaction reference, universally unique identifier (UUID) generation with site affinities, etc. The services are hosted within the enterprise service bus (ESB) and communicate using messaging layer. The service layer is stateless while orchestrations are stateful. Complex event processing systems are used to manage and maintain the states as well as the state transformation machines.

One of the key functions hosted out of the services layer is integration with a persistence layer 406. The persistence 406 is provided by a Data Grid. The data access is abstracted at the service bus. The data access functions facilitate replication of data across all data grids where replication is addressed as part of the business transaction. This allows provisioning of additional system capacity in a near linear scalable fashion. Additional capacity can also be provisioned on demand. This design approach also allows for quick re-purposing of capacity for other functions. For example, the document rendering/processing capacity could be increased during end of the financial year period for capacity and service level management.

The CFMS 105 will have several service buses to meet requirements in different security zones:
a) External Demilitarized Zone (DMZ), to allow for functions such as duplicate transaction detection, enforcement of allowable usage types, and address allocation maps.
b) Document processing, to allow for all orchestration to process, store and retrieve documents. There are a few integrations with bespoke code, and appliances.
c) Internal, will include all other technical services. The internal services includes where orchestrations span stacks and/or sites. Orchestration across stacks, sites may be used where replication is part of business transaction.

Another layer within the CFMS 105 is an events processing layer 407 which is the control tier of the CFMS applications. One of the core functions that this application layer provides is managing and maintaining transaction states. This is achieved by state-transition-machines. State machines are defined for each transaction flows. It is the state machine that orchestrates the transactions provides event correlation with the other components of the CFMS 105 such as document processing provides the time-based event processing for TTRs.

The state machines are typically initialised by the first message/event in a transaction or instruction received by the CFMS 105—in this example a payment request 206 with an attached invoice. Subsequent processing and functions performed on the transaction result in events being generated. These events are relayed back to the state machine and based on the event it undergoes state changes. Once a transaction is complete and committed—in this case the payment is written to the payments file, the state machine is destroyed.

The event processing engine is also used for real-time collection of intelligence, such as fraud and statistical data generation for the user identifier. These statistics are kept hot and up to date as transactions are processed.

As mentioned above, the persistence is achieved by a data grid which is coordinated by a persistence layer 406. Geographic reach of the data grid together with a data grid provide internal replication in real-time to both the intra and inter grid members. The data grid will be built to provide a deterministic N+1 or better redundancy. This will allow the data grid to autonomously recover from component failures, sacrificing neither the data quality nor the data reliability. Persistence applies to entities that need to be persisted and entities that need to be accessible for all of above to work.

The CFMS 105 applies a shared nothing architecture. In order to achieve higher resilience and availability, non-blocking and near linear performance scalability, the data grid nodes will make use of direct attached storage. This also removes any single points of contention and single points of failure from the persistence tiers. This also reduces complexity in design by removing the need for Storage Area Network (SAN).

The data within the CFMS 105 needs to be consistent across all data centres. This requires data to be distributed as the data changes as part of various transaction flows. Within a transaction flows there are predefined commit points where recoverability and consistency needs to be provided. For example, at some key points the system needs to provide that data is also at the other data centre. These two points need to be synchronous. However, all other replication and data distribution within this transaction flow can be asynchronous.

The CFMS 105 further comprises a document processing layer 408. The CFMS 105 will be processing documents included as attachments, such as payment requests or payment confirmations. This is for use where a document, a uniform resource locator (URL), uniform resource identifier (URI) or a document identifier is attached to the message.

The CFMS 105 further comprises a security layer 409. The security layer 409 performs identity and access management employing a multi-factor authentication subsystem, a Certification Authority (CA) component and a role based access control subsystem. The multi-factor authentication subsystem provides strong authentication and integration with the federation components for admin and operator authentication and access control. The CA component provides X.509 certificate provisioning and management facility. The CA also provides a Certificate Revocation List (CRL) and Online Certificate Status Protocol (OCSP) services to ascertain validity/currency of X.509 certificates as part of the mutual authentication flow. The role based access control sub system will link identity to entity and their roles and access rights.

The security layer 409 also performs Security Incident and Events Management (SIEM), exception handling and management. To perform these tasks the security layer 409 employs logging components and correlation engines. The logging components provide a centralised facility to log all the messages and events, including network devices, security devices and services. This information can be used to debug and trace events and correlations between various events. The correlation engines are used to identify related events, patterns for security and other compliance escalations.

The security layer 409 also performs operational monitoring and maintenance, such as vulnerability assessment including intrusion detection and internal and external vulnerability scanning.

Further, the CFMS 105 comprises a monitoring layer 410. As part of the handover to Technology Operations and production readiness five scenarios will be tested to meet the integrity and recoverability targets:
deep polling and synthetic transactions;
split-brain;
recovery;
cold boot; and
application maintenance and upgrades.

Split-brain can happen if one data centre hosting the CFMS 105 looses visibility to the other data centre and as a result islands itself. This may force each data centre to autonomously infer that it is the last surviving node and the other node is down. Automatic detection of split-brain using third party quorum, majority detection which would result in one of the two data centres to be taken down as active to pending consistency status.

The layering of applications within the CFMS 105 in this form allows for seamless horizontal and vertical scalability by bolstering components at each layer as required. This specific design also assists in managing performance and service levels and helps in limiting the impact of changes which will be required during the lifecycle of the CFMS 105. As a result, the overall maintainability, scalability and in turn availability of the CFMS 105 is improved. For example, introduction of messaging based on the Advanced Message Queuing Protocol (AMQP) will only require additions to the integration layer 401 and mediation layer 404.

An example of using the application layers of the CFMS 105 will now be described. This example relates to a payment where an invoice and a remittance advice is exchanged between the payer and the payee. The payment request 240 in FIG. 2a, including document data related to the invoice arrives at the CFMS 105 as an encrypted Extensible Markup Language (XML) message.

In one example the document data is the invoice itself and the CFMS 105 generates a document reference and a document identifier and stores the invoice associated with the document identifier. In a different example, the document data is a document reference to the invoice stored on an external document storage host. The CFMS 105 generates the document identifier and registers the document associated with this document identifier. In yet another example, the invoice has already been registered and the document data includes the document identifier. In that case the CFMS 105 determines the document identifier simply by reading the document identifier from the XML code of the message.

The message is received by a web service of the integration layer 401. In other examples the message is received via an encrypted channel, such as IPsec, between the payee FI 104 and the CFMS 105. The integration layer 401 sends a transport level acknowledgment to the payee FI 104.

The message is handed over to the mediation layer 404, which converts the message from the outside schema to an inner schema. The mediation layer 404 converts messages from various different protocols into the same inner schema. Now that the message is in a suitable format for internal layers, it is forwarded to the application switching layer 402. The application switching layer 402 validates the encryption of the message including the validity of the key and routes the message to the appropriate module of the services layer 405.

In a different example, the integration layer, mediation layer and application switching layer are combined into a communication and mediation layer. This communication and mediation layer may act as an input and then receives an input message from an external sender, validates the input message and sends the input message to the internal service layer 405. This communication and mediation layer may also act as an output and receive an output message from the internal service layer 405 and send the output message to an external receiver.

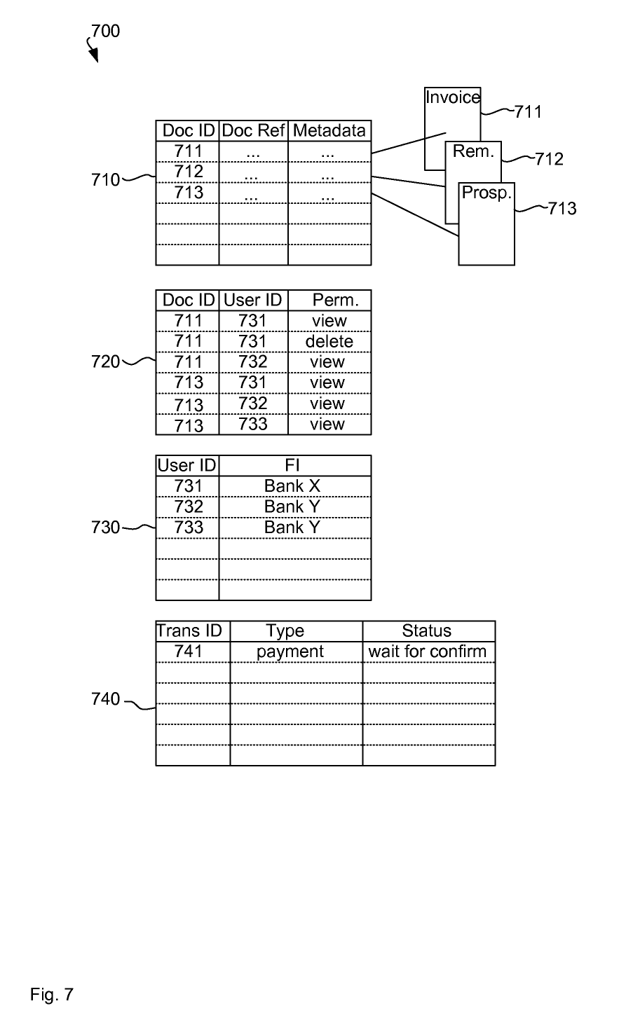

The services layer 405 orchestrates the communication pattern that is necessary for completing the document handling process. As mentioned above, the service layer 405 is stateless and therefore, the services layer 405 instructs the events processing layer 407 to initialise a state machine according to a predefined communication pattern. This state machine information needs to be persistently stored in a transaction data table in the persistence layer 406 even in the event of a failure of an entire data centre, such as in case of a natural disaster. Therefore, at this stage, the state machine information is duplicated to a second data centre in sufficient geographical distance from the first data centre. Other data that needs to be stored includes a document table, an access control table and a user data table. These tables will be explained in more detail with reference to FIG. 7. The further processing of the request needs to wait for the completion of the storing of all the data at the second data centre.

When a payment request is first received 244 by the CFMS 105 the state machine is initialised and made durable in the persistence layer 406 and the services layer 405 can query the state machine for the next step. In this case, the next step is to validate the payment request and determine the payer FI from the user data table. CFMS 105 determines whether the attached document data includes the invoice, a document reference or a document identifier. Accordingly, the CFMS 105 stores the appropriate data in the data tables and makes these changes durable. If the attached document data includes the invoice, the document is processed by the document processing layer 408. This includes document conversion, document decryption and content validation.

Then, the service layer 405 generates a message including the payment request and the document identifier for the payer FI 102. This message passes through the application switching layer 402, the mediation layer 404 and the integration layer 401. The message is then sent to the payer FI 102. This starts a timer to detect a time out of the response of the payer FI 102. After technical validation by the payer FI 102, the integration layer 401 receives a response message acknowledging the correct transmittal of the payment request. This acknowledgement is passed to the mediation layer 404 to further monitor the responsiveness of the payer FI 102.

Once the payer FI 102 generates a confirmation and sends it to the CFMS 105, the confirmation is received by the integration layer 401 and passes through the mediation layer 404 and the application switching layer 402 to the services layer 405. Receiving the confirmation prompts the services layer 405 to advance the state of the state machine stored in the persistence layer 406 to the next state. As mentioned previously, the state of the state machine needs to be persistent and therefore, the duplication of the state change to a second data centre is again necessary.

When the payer FI 102 sends a payment notification the receiving and sending of the payment notification by the CFMS 105 follows a similar scheme as the three party scheme described above.

When the receiver of a document requests to view that document, the delivery of the document via a web interface is performed by the document processing layer 408.

In one alternative document storage is facilitated by the sender FI. The sender uploads the document to the sender FI and the sender FI stores 212 the document with the storage host on the sender's behalf.

FIG. 5 illustrates a state transition diagram 500 for the state machine stored in the persistence layer. Payment requests, and payment notifications are associated with a specific payment transaction via the transaction identifier as described above. In turn, each payment transaction is associated with one state machine. As a result, when receiving a message related to a specific transaction, such as the payment request and the related payment notification, the service layer can access the state machine and the current state stored in the persistence layer 406 for that transaction.

In this example, an invoice is attached to the payment request including from a merchant and a remittance advice is attached to the payment notification or authorisation confirmation.

The state transition diagram 500 comprises three states, waiting for payment request 502, waiting for payment notification 504 and settlement 508.

After initialisation the current state of the state machine is wait for payment request 502. In a different example, the state machine is not initialised before a payment request is received. As a result, the state of wait for payment request is not required in that example.

The communication and mediation layer as described above receives an input message from a sender, validates the input message and sends the input message to the service layer 405. Examples of validation are described above.

The service layer to receives from the communication and mediation layer the input message and determines a receiver FI based on the receiver user identifier and the user data in the persistence layer.

In a first case a document file is attached to a message to a receiver and the document needs to be stored and registered. In that case the input message includes a receiver user identifier, a document file and includes no document request. The service layer stores in the persistence layer the document file creating a document reference, stores in the persistence layer the document reference, generates and store in the persistence layer a document identifier associated with the document reference. The service layer creates the output message having the receiver FI as recipient. The service layer then to includes the document identifier into the output message, and sends the output message to the communication and mediation layer.

In a second case a document reference is attached to a message to a receiver and the document reference needs to be registered. In that case the input message includes a receiver user identifier, a document reference that is a reference to a document stored on an external document storage and includes no document request. The service layer stores in the persistence layer the document reference, generates and stores in the persistence layer a document identifier associated with the document reference. The service layer creates the output message having the receiver FI as recipient. The service layer then includes the document identifier into the output message and sends the output message to the communication and mediation layer.

In a third case a document identifier is attached to a message to a receiver, that is the document has already been registered. In that case the input message includes a receiver user identifier, a document identifier created by the computer system and includes no document request. The service layer creates the output message having the receiver FI as recipient. The service layer includes the document identifier into the output message and sends the output message to the communication and mediation layer.

In a fourth case the sender requests a document. In that case the input message includes a document identifier and a document request. The service layer determines the rights of the sender for accessing the document, retrieves from the persistence layer the document reference associated with the document identifier and provides based on the rights of the sender for accessing the document access to the document.

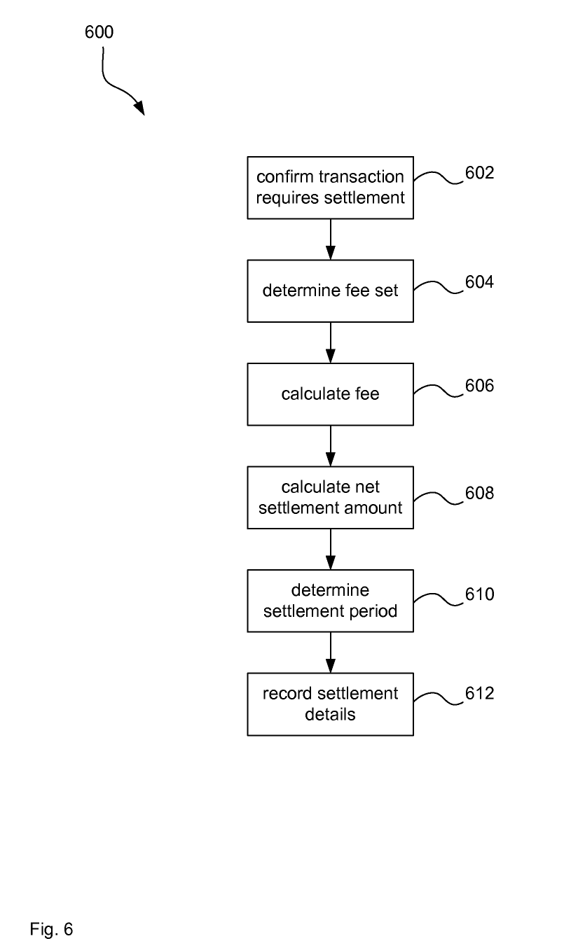

FIG. 6 illustrates a method 600 for creating settlement details. The method 600 commences by confirming 602 that the transaction requires settlement. The confirmation 602 comprises determining a transaction type, a transaction pattern and the number of parties involved in the transaction pattern. If the number of parties involved is 3 or 4 the method continues with the next step, otherwise settlement is not required and method 600 terminates.

The next step of method 600 is to determine 604 an appropriate interbank fee set. This step comprises determining the payee FI and the payer FI, determining whether there is a set of interbank fees for this pair of FIs and if yes using the specific set of interbank fees. If no set of interbank fees can be found for this pair of FIs, a predetermined default set of interbank fees is used.

After determining the set of interbank fees the method then calculates 606 the interbank fee and fee direction. For that, the method determines the characteristics of the transaction relevant to settlement, that is transaction type, fee basis for each user identifier, transaction attachments, and payment amount. From the appropriate set of interbank fees the method also matches the transaction characteristics with the interbank fee characteristic. If a match is found, the transaction interbank fee is calculated as:

a flat fee (if stated)+the fee rate in percent*payment amount.

The calculated fee may then be corrected by applying a minimum and maximum interbank fee. Finally, the fee direction as read from the set of interbank fees.

With the calculated fee the net settlement amount is then calculated 608. This is achieved by either adding to or subtracting from the payment amount the calculated fee depending on the fee direction.

The method then determines 610 the settlement period details. This step comprises based on a timestamp of the committed transaction determining the next closing date and time for settlement and identifying an associated settlement period ID and banking business day.

The last step of method 600 is to record 612 the settlement details. The recorded data comprises in this example:
transaction amount;
interbank fee amount and non-GST settlement amount determined in step 606;
the user identifier of the payer;
the user identifier of the payee;
settlement period details determined in step 610;
transaction type;
fee basis and version number of the payer user identifier; and
fee basis and version number of the payee user identifier.

Before the transaction details are recorded in a settlement record table, this table is updated. Then it is determined whether there is an entry in the table that matches the settlement period ID, closing date and time of the settlement period, banking business day, payer user identifier, payee user identifier, source account type, transaction type, attachment indicator, fee basis of the payer user identifier and fee basis of the payee user identifier. If no match is found, a new record is written to the settlement record table and a transaction count is incremented by 1.

After that the transfer amount, the interbank fee amount and the settlement amount are added to the respective base amounts. Then, a record is added to the settlement details table.

FIG. 7 illustrates data 700 on a data store comprising a document table 710, an access control table 720, a user data table 730 and a transaction data table 740. The tables are accessed by different layers from FIG. 4. For example, the document table 710 and access control table 720 are accessed by the document processing layer 408 while the transaction data table 740 is accessed by the event processing layer 407.

The document table 710 stores data related to documents registered with the CFMS 105. Each entry in the document table 710 stores the association between the document identifier, the document reference and the document metadata. When in use, the CFMS 105 accesses the document table 710 to store a new entry when a new document is registered. The CFMS 105 retrieves the document data and in particular the document reference when the document is requested. In this example, three document are registered, that is an invoice 711, a remittance advice 712 and a prospectus 713.

The access control table 720 stores information about which user has certain rights to certain documents. It is noted that one document identifier can have multiple entries in the access control table 720. In this example, a first user 731 has permission to view and delete document 711 while a second user 732 has permission to only view document 711. Typically, if document 711 is an invoice user 731 is the payee who has sent the invoice to user 732 who is the payer. The payee 731 can view and delete the invoice while the payer 732 can only view the invoice. Similarly, if the document 712 is a remittance advice, a payer can view and delete the remittance advice while the payee can only view the remittance advice. In contrast, the prospectus 713 may be sent to many different users and therefore the access control table stores many entries to grant permission to view the prospectus to many users.

Every time a document is attached to a transaction from a sender to a receiver, the CFMS 105 checks whether an entry already exists in the access control table and if not creates a new entry allowing the sender to view and delete the document and the receiver to view the document. The ability to delete, that is to recall a document by the sender is subject to certain controls. Not all documents can be recalled. A document can be recalled by the sender if an action involving a payment has not been yet made by the receiver. For example, if an invoice is attached to a payment request and the payer subsequently makes a payment against that payment request, the invoice can no longer be recalled by the sender.

The user data table 730 stores an association of the user identifier with an FI. In this example, user 731 has an account with bank X while users 732 and 733 have their accounts with bank Y. When a new user registers with the CFMS 105, the CFMS 105 creates a new entry in the user data table. When a sender sends any transaction to that user identifier as receiver, the CFMS 105 queries the user data table 730 to determine the FI of the receiver and sends the transaction to the receiver's FI.

The transaction data table 740 stores data related to transactions which are currently pending. In this example, transaction 741 is a payment request and the CFMS 105 is waiting for a payment confirmation from the payer FI. The CFMS 105 creates a new entry when the state machine is created. When the transaction is finished, such as by settling the payment, the entry in the transaction table 740 is deleted.

In other forms a formal association between the transaction identifier and document identifier could be made in the datastore.

It should be understood that the techniques of the present disclosure might be implemented using a variety of technologies. For example, the methods described herein may be implemented by a series of computer executable instructions residing on a suitable computer readable medium. Suitable computer storage is readable media may include volatile (e.g. RAM) and/or non-volatile (e.g. ROM, disk) memory, carrier waves and transmission media. Exemplary carrier waves may take the form of electrical, electromagnetic or optical signals conveying digital data streams along a local or wide area network or a publicly accessible network such as the internet.

It should also be understood that, unless specifically stated otherwise as apparent from the following discussion, it is appreciated that throughout the description, discussions utilizing terms such as “receiving”, “sending”, “processing” or “computing” or “calculating”, “optimizing” or “estimating” or “determining” or “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

It will be appreciated by persons skilled in the art that numerous variations and/or modifications may be made to the above-described forms, without departing from the broad general scope of the present disclosure. The present forms are, therefore, to be considered in all respects as illustrative and not restrictive.

What is claimed is:

1. A computer implemented method performed by a central financial management system for enabling a user to access a document, the method comprising:
(a) receiving from a sending party document data describing the document and a user identifier;
(b) determining a document identifier associated with the document data;
(c) determining the receiving financial institution (receiving FI) based on the user identifier;
(d) sending to a receiving FI the document identifier and the user identifier to cause the receiving FI to provide information related to the document identifier to the user associated with the user identifier such that the user can request the document;
(e) receiving from the receiving FI a request to enable access to the document for the user, the request including the document identifier;
(f) determining a document reference and a document storage provider associated with the received document identifier; and
(g) enabling access for the user associated with the user identifier to the document stored at the storage provider associated with the document reference.

2. The computer implemented method according to claim 1, wherein the document data includes the document reference and step (b) of determining a document identifier comprises generating the document identifier and storing on a datastore an association between the document reference and the document identifier.

3. The computer implemented method according to claim 1, wherein the document data includes the document and step (b) of determining a document identifier comprises
storing the document on a datastore;
determining a document reference as the reference to the document on the datastore;
generating a document identifier associated with the document; and
storing on the datastore an association between the document and the document identifier.

4. The computer implemented method according to claim 2, wherein the method further comprises validating the document reference or document.

5. The computer implemented method according to claim 1, wherein step (b) further comprises determining the receiving FI based on the user identifier and user data stored on a datastore of the central financial management system having the associated with each user identifier a financial institution.

6. The computer implemented method according to claim 1, wherein the method is executed in real time.

7. The computer implemented method according to claim 1, wherein the user identifier is associated with a financial transaction.

8. A non-transitory computer readable medium with an executable program stored thereon that when executed causes a computer to perform the computer implemented method according to claim 1.

9. A computer system of a central financial management service provider for enabling a user to access a document, the system comprising:
one or more communication ports; and
one or more processors to operate the communications port to:
(a) receive from a sending party document data describing the document and a user identifier;
(b) determine a document identifier associated with the document data;
(c) determine the receiving financial institution (receiving FI) based on the user identifier;
(d) send to a receiving FI the document identifier and the user identifier to cause the receiving FI to provide information related to the document identifier to the user associated with the user identifier such that the user can request the document;
(e) receive from the receiving FI a request to enable access to the document for the user, the request including the document identifier;
(f) determine a document reference and a document storage provider associated with the received document identifier; and
(g) enable access for the user associated with the user identifier to the document stored at the storage provider associated with the document reference.

10. A computer system for enabling a user to access a document where the document is sent to the user, the computer system comprising:
a persistence layer to store user data including a user identifier and associated user financial institution (FI), and, a document identifier and associated storage provider and user rights access;
a communication and mediation layer to receive an output message from a service layer, to send the output message to a recipient, to receive an input message from a sender, to validate the input message and to send the input message to the service layer; and
the service layer
to receive from the communication and mediation layer the input message,
where the input message includes a user identifier and document data, to determine a document identifier associated with the document data, to determine the FI based on the user identifier and the user data in the persistence layer; to create an output message having the FI as the recipient and including the document identifier and the user identifier that cause the FI to provide information related to the document identifier to the user associated with the user identifier such that the user can request the document, to send the output message to the communication and mediation layer, and
where the input message includes a request to enable access to the document for the user and includes the a document identifier, to determine a document storage provider and user access rights associated with the document identifier based on the document identifier in the persistence layer, to create an output message that will enable access to the document by the user from the storage provider, to send the output message to the communication and mediation layer.

11. A computer implemented method performed by a financial institution of a sender for providing a document to a user, the method comprising:
(a) receiving from the sender a request to register the document including document data describing the document and a user identifier; and
(b) sending to a central financial management system a message including the request to register the document.

12. A non-transitory computer readable medium with an executable program stored thereon that when executed causes a computer to perform the method according to claim 11.

13. A computer system of a financial institution of a sender for providing a document to a user, the system comprising:
one or more communications ports; and
one or more processors to operate the communications port and to perform the method of claim 11.

14. A computer implemented method performed by a financial institution of a user to enable access to a document sent by a sender to the user, the method comprising:
(a) receiving a document identifier and a user identifier;
(b) determining the user associated with the user identifier;
(c) providing information related to the document identifier to the user associated with the user identifier
(d) receiving from the user a request for the document associated with the document identifier; and
(e) sending a request to enable access to the document for the user, the request including the document identifier.

15. A non-transitory computer readable medium with an executable program stored thereon that when executed causes a computer to perform the computer implemented method according to claim 14.

16. A computer system of a financial institution of a user for facilitating a payment from a payer to a payee, the system comprising:
one or more communications ports; and
one or more processors to operate the communications port and to perform the computer implemented method according to claim 14.
